(19) United States
(12) Patent Application Publication
(10) Pub. No.: US 2015/0255087 A1
(43) Pub. Date: Sep. 10, 2015

(54) VOICE PROCESSING DEVICE, VOICE PROCESSING METHOD, AND COMPUTER-READABLE RECORDING MEDIUM STORING VOICE PROCESSING PROGRAM

(71) Applicant: FUJITSU LIMITED, Kawasaki-shi (JP)

(72) Inventors: Takeshi Otani, Kawasaki (JP); Taro Togawa, Kawasaki (JP); Chisato Shioda, Kawasaki (JP)

(73) Assignee: FUJITSU LIMITED, Kawasaki-shi (JP)

(21) Appl. No.: 14/627,516

(22) Filed: Feb. 20, 2015

(30) Foreign Application Priority Data
Mar. 7, 2014 (JP) 2014-045447

(51) Int. Cl. G10L 25/48; G10L 15/22; G10L 15/08

(52) U.S. Cl. CPC G10L 25/48; G10L 15/08; G10L 15/22

(57) ABSTRACT

A voice processing device includes a backchannel-response detector configured to detect, from a first voice signal including a voice of a first speaker, a backchannel-response segment including a voice corresponding to a backchannel response made by the first speaker, using, a start point of a first voice segment detected from the first voice signal, an end point of a second voice segment detected from a second voice signal including a voice of a second speaker uttered before the voice of the first speaker, and the number of vowels detected from the first voice segment of the first voice signal.

### CROSS-REFERENCE TO RELATED APPLICATION

This application is based upon and claims the benefit of priority of the prior Japanese Patent Application No. 2014-045447, filed on Mar. 7, 2014, the entire contents of which are incorporated herein by reference.

### FIELD

The embodiments discussed herein are related to a voice processing device, a voice processing method, and a computer-readable recording medium storing voice processing program.

### BACKGROUND

Recent advances in voice recognition technology have led to growing demands for acquiring more information from voice data. For example, the feelings of a speaker are often reflected in a “backchannel or supportive response”, often used as an appropriate word spoken while the other person is speaking, in a conversation. For this reason, a technology for estimating the emotion of a speaker by detecting a “backchannel response” from voice data and analyzing voice information of the “backchannel response” is being studied. In such a case, a technique for detecting a backchannel response from voice data with high accuracy is desired.

To meet this desire, techniques for determining an intention of an utterance from the rhythm of an entire sentence and the voice quality of a speaker are known (for example, refer to Japanese Laid-open Patent Publication No. 2010-217502, Japanese Laid-open Patent Publication No. 2011-142381, and Japanese Laid-open Patent Publication No. 2011-76047). As a related technique, a technique of detecting a voice segment from a voice signal including noise is known (for example, refer to Japanese Laid-open Patent Publication No. 2004-272052). In addition, a technique for detecting a vowel is known (for example, refer to “Voice 1”, online, last accessed on Mar. 6, 2014 <URL: http://media.sys.wakayama-u.ac.jp/kawahara-lab/LOCAL/diss/diss7/S3_{—}6.htm>).

### SUMMARY

According to an aspect of the invention, a voice processing device includes a backchannel-response detector configured to detect, from a first voice signal including a voice of a first speaker, a backchannel-response segment including a voice corresponding to a backchannel response made by the first speaker, using, a start point of a first voice segment detected from the first voice signal, an end point of a second voice segment detected from a second voice signal including a voice of a second speaker uttered before the voice of the first speaker, and the number of vowels detected from the first voice segment of the first voice signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a functional configuration of a voice processing device according to a first embodiment;

FIG. 2 is a diagram depicting an example of a backchannel response according to the first embodiment;

FIG. 3 is a flowchart illustrating operations of the voice processing device according to the first embodiment;

FIG. 4 is a block diagram illustrating an example of a functional configuration of a voice processing device according to a second embodiment;

FIG. 5 is a diagram depicting an example of a vowel segment detection method according to the second embodiment;

FIG. 6 is a diagram depicting an example of a method of computing the number of vowels according to the second embodiment;

FIG. 7 depicts an example of a threshold table according to the second embodiment;

FIG. 8 depicts an example of a voice segment table according to the second embodiment;

FIG. 9 is a diagram illustrating an example of time difference data according to the second embodiment;

FIG. 10 depicts a diagram of a vowel segment table according to the second embodiment;

FIG. 11 is a diagram illustrating an example of vowel number data according to the second embodiment;

FIG. 12 is a flowchart illustrating operations of a voice processing device according to the second embodiment;

FIG. 13 is a diagram depicting an example of a vowel segment detection method according to a first modification;

FIG. 14 is a diagram depicting an example of a backchannel response according to a second modification;

FIG. 15 is a block diagram illustrating a functional configuration of a voice processing device according to a third embodiment;

FIG. 16 is a diagram depicting an example of a method for determining a vowel type utilizing LPC analysis according to the third embodiment;

FIG. 17 depicts an example of a result obtained by performing FFT and smoothing on a voice signal in a predetermined time period of a detected vowel segment according to the third embodiment;

FIG. 18 is a diagram depicting an example of a variation in pitch according to the third embodiment;

FIG. 19 depicts an example of a variation table according to the third embodiment;

FIG. 20 is a diagram of a table depicting an example of a dictionary according to the third embodiment;

FIG. 21 is a flowchart illustrating operations of a voice processing device according to the third embodiment;

FIG. 22 is a block diagram illustrating an example of a configuration in the case where the voice processing device according to the embodiment is applied to a telephone set; and

FIG. 23 is a block diagram illustrating an example of a hardware configuration of a standard computer.

### DESCRIPTION OF EMBODIMENTS

However, in the method in the background in which an intention of an utterance is determined based on rhythms, the uttered sentence significantly affects the determination. In the technique in which a determination is made based on voice quality, the differences among individuals and the differences among regions are large. For such reasons, there is a problem in that when a backchannel response is detected from rhythms or voice quality, the accuracy of determining a backchannel response is reduced.

Accordingly, it is desired to enable a backchannel response to be detected with high accuracy.

Hereinafter, a voice processing device according to the embodiments will be described with reference to the accompanying drawings. The voice processing device uses a start point of a first voice segment and an end point of a second voice segment. The first voice segment is detected from a first voice signal including a voice of a first speaker and a second voice segment is detected from a second voice signal including a voice of a second speaker uttered before the voice of the first speaker. Additionally, the number of vowels detected from the first voice segment of the first voice signal is used. Using the start point of the first voice segment, the end point of the second voice segment, and the number of vowels, a backchannel-response detector detects, from the first voice signal, a backchannel-response segment including a voice corresponding to a backchannel response made by the first speaker.

The backchannel response is an interjection uttered for indicating that the speaker understands and is interested in the utterance of his or her conversation partner. The voice processing device may be used to detect a backchannel response, for example, in a voice for communication. The voice processing device may be included in communication equipment such as a telephone set, for example. The voice processing device may be configured as an information processing device that reads and executes a predetermined program.

### First Embodiment

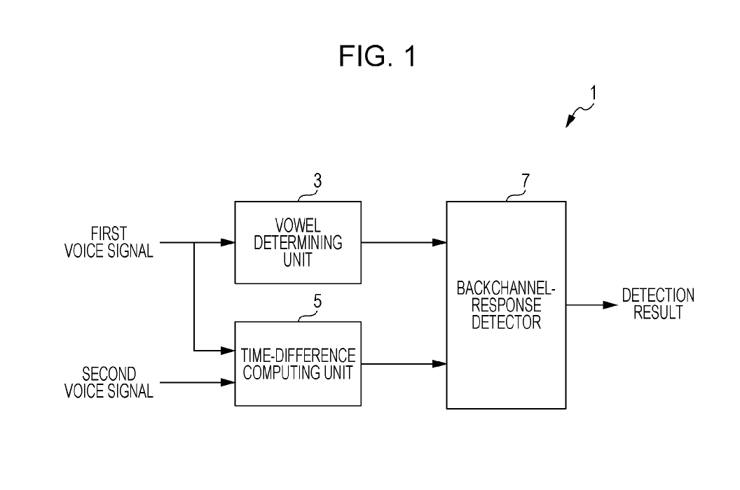

A voice processing device 1 according to a first embodiment will now be described. FIG. 1 is a block diagram illustrating a functional configuration of a voice processing device 1 according to the first embodiment. As illustrated in FIG. 1, the voice processing unit 1 includes a vowel determining unit 3, a time-difference computing unit 5, and a backchannel-response detector 7. These functions may be functions that are implemented when a processing unit included in the voice processing device 1 reads and executes a predetermined program.

The time-difference computing unit 5 computes a time difference between the start point of the first voice segment and the end point of a second voice segment, where the first voice segment is detected from a first voice signal including a voice of a first speaker and the second voice segment is the end point of a second voice segment detected from a second voice signal including a voice of a second speaker. That is, the time-difference computing unit 5 computes a time difference between the start point of the first voice segment and the end point of the second voice segment. The vowel determination unit 3 determines the number of vowels in the voice signal of the first voice segment.

Note that, as a method for detecting a voice segment from a voice signal, known techniques described in, for example, Japanese Laid-open Patent Publication No. 2004-272052 and the like may be used. By using such techniques, relative time points of the start and end points of a voice segment in a voice signal are output.

The backchannel-response detector 7 determines that the first voice segment is a backchannel segment when the time difference calculated by the time-difference computing unit 5 is shorter than a predetermined value and when the number of vowels determined by the vowel determining unit 3 is within a predetermined number. The backchannel-response detector 7 may determine that a backchannel response is included in the first voice signal.

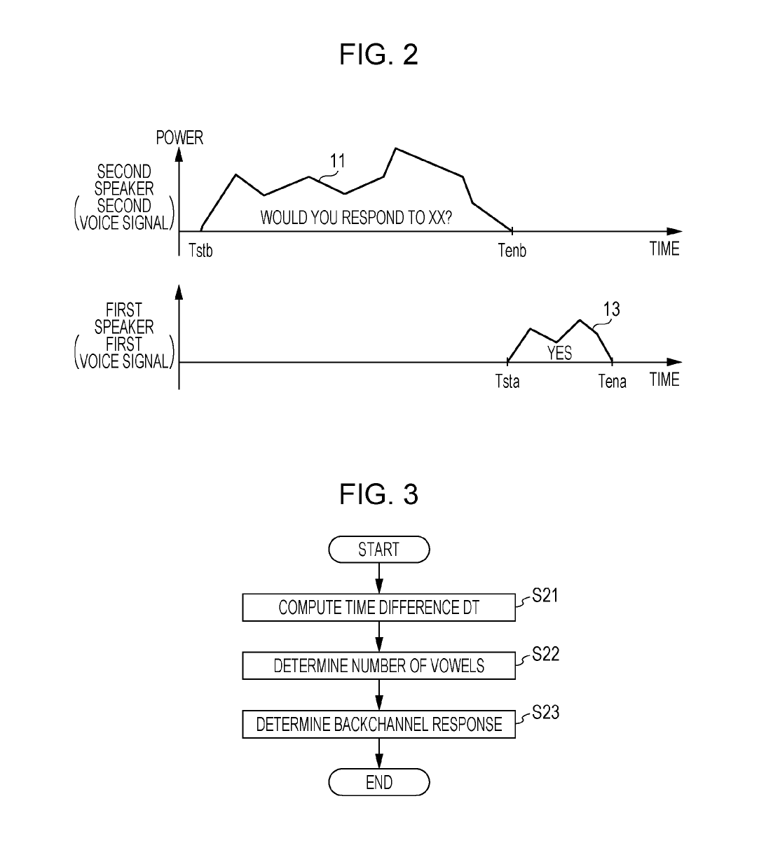

FIG. 2 is a diagram depicting an example of a backchannel response according to the first embodiment. In FIG. 2, the horizontal axis represents time, and the vertical axis represents the power of a voice signal. A second voice signal 11 represents a signal corresponding to an utterance of a second speaker saying, for example, “Would you respond to xx?” A first voice signal 13 represents a signal corresponding to a backchannel response “Yes” uttered to the second voice signal 11.

In this case, the second voice segment is determined to be from a start point Tstb to an end point Tenb of the second voice segment. The first voice segment is determined to be from a start point Tsta to an end point Tena of the first voice segment. A voice segment may be determined, for example, by using a related-art method, such as a method in which a voice segment is determined by the flatness of a frequency distribution of a voice signal, as is the case in the method described in Japanese Laid-open Patent Publication No. 2004-272052. Note that the start points and end points of the first voice segment and the second voice segment may be relative time points.

A backchannel response is considered to occur during or immediately after an utterance of the conversation partner. Consequently, the backchannel-response detector 7 determines a backchannel response based on a time difference DT between the start point Tsta of the first voice segment and the end point Tenb of the second voice segment. That is, it is assumed that the time difference DT is expressed by the following Formula 1.

DT=Tsta−Tenb (1)

At this point, the time difference may be within a time period determined in advance. That is, the following Formula 2 is satisfied.

−t1≦DT≦t2 (2)

where a time period t1 and a time period t2 are both positive real numbers. The time period t1 and the time period t2 may determine, for example, a time difference of a backchannel response that is statistically probable, from actual conversations including backchannel responses. Note that the time period t1 and the time period t2 may be stored in a threshold table 45 described below.

Another feature of a backchannel response is that the backchannel response is formed of a small number of vowels. That is, examples of backchannel responses in Japanese may include “ee”, “hai”, “aa”, “un”, “iie”, and “iya”. These are sounds each including a small number of vowels. The small number may be assumed to be, for example, less than three. The number of vowels may be determined by analyzing a formant frequency included in a voice segment to identify a vowel, for example, by using the method described in “Voice 1”.

The backchannel-response detector 7 outputs the first voice segment as a backchannel-response segment when the start point Tsta of the first voice segment and the end point Tenb of the second voice segment satisfy the relationship of Formula 2 and when the number of vowels included in the first voice segment is within the predetermined number.

FIG. 3 is a flowchart illustrating operations of the voice processing device 1 according to the first embodiment. As illustrated in FIG. 3, the time-difference computing unit 5 computes the time difference DT using the detected first and second voice segments (S21). The vowel determining unit 3 determines the number of vowels included in the first voice segment (S23). The backchannel-response detector 7 determines that the first voice segment is a backchannel-response segment when the time difference DT satisfies Formula 2 and when the number of vowels is equal to or less than the predetermined number (S23).

As described above, with the voice processing device 1 according to the first embodiment, the time-difference computing unit 5 computes the time difference DT between the start point Tsta of the first voice segment and the end point Tenb of the second voice segment. The vowel determining unit 3 determines the number of vowels included in the first voice segment. The backchannel-response detector 7 determines that the first voice segment Tsta to Tena is a backchannel-response segment when the time difference DT satisfies Formula 2 and when the number of vowels of the first voice segment is equal to or less than the predetermined number.

With the voice processing device 1 according to the first embodiment, it is possible to detect a backchannel response using the start point of the first voice segment, the end point of the second voice segment, and the number of vowels included in the first voice segment, rather than voice quality and rhythms. That is, the voice processing device 1 may detect a backchannel-response segment by narrowing a temporal range of presence of a backchannel-response segment, for example, from utterance timings of the person on the other end of the phone and an utterer, detecting vowels from acoustic features, and counting vowel segments in accordance with variations in formant frequency or the like. In such a way, detection of a backchannel response with the voice processing device 1 uses neither vocal quality nor rhythms and thus may be made with high accuracy without being affected by the meaning of a sentence, the differences among individuals as speakers, and the differences among regions.

### Second Embodiment

A voice processing device 20 according to a second embodiment will now be described. In the second embodiment, configurations and operations similar to those in the voice processing device 1 according to the first embodiment are denoted by the same reference numerals, and redundant description thereof is omitted.

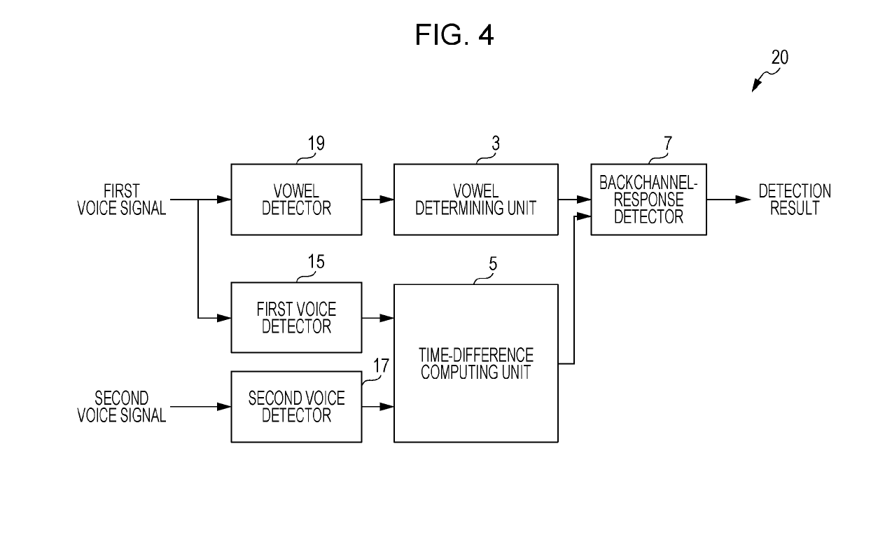

FIG. 4 is a block diagram illustrating an example of a functional configuration of the voice processing device 20 according to the second embodiment. As illustrated in FIG. 4, similar to the voice processing device 1, the voice processing device 20 includes the vowel determining unit 3, the time-difference computing unit 5, and the backchannel-response detector 7. The voice processing device 20 further includes a first voice detector 15, a second voice detector 17, and a vowel detector 19. As in the voice processing device 1 according to the first embodiment, the above-mentioned functions may be functions that are implemented when a predetermined program is read and executed, for example, by a processing unit included in the voice processing device 20.

The first voice detector 15 detects the first voice segment from the first voice signal, and outputs the start point Tsta and the end point Tena of the first voice segment to the time-difference computing unit 5. The second voice detector 17 detects the second voice segment from the second voice signal and outputs the start point Tstb and the end point Tenb of the second voice segment to the time-difference computing unit 5. The vowel detector 19 detects vowel segments in the first voice signal and outputs the detected vowel segments to the vowel determining unit 3.

The vowel determining unit 3 determines the number of vowels included in the first voice segment using vowel segments input from the vowel detector 19. The time-difference computing unit 5 computes the time difference DT using the first and second voice segments detected by the first voice detector 15 and the second voice detector 17. The backchannel-response detector 7 detects a backchannel response based on the number of vowels and the time difference DT.

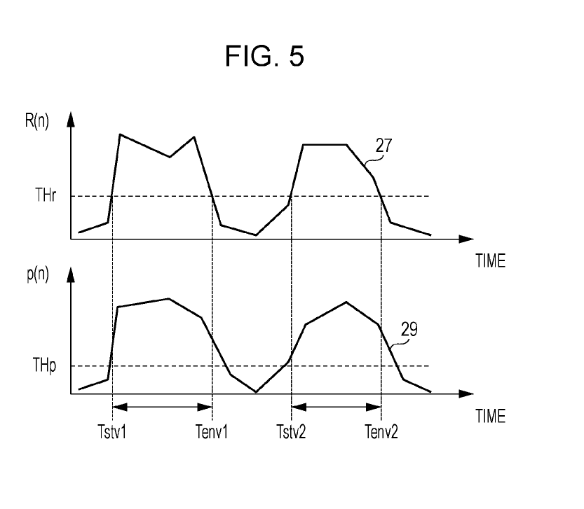

FIG. 5 is a diagram depicting an example of a vowel segment detection method according to the second embodiment. The method for detecting vowel segments illustrated in FIG. 5 is a method in which autocorrelation and power of the first voice signal are analyzed for each predetermined time period, so that vowel segments are detected. In FIG. 5, assuming that the horizontal axis represents a variable n corresponding to a predetermined time period (also called a frame), autocorrelation 27, which is an example of autocorrelation R (n), and power 29, which is an example of power p (n), are represented. The autocorrelation R (n) is assumed to use a value expressed by Formula 3 given below. The power p (n) is assumed to be expressed by Formula 4 given below.

Note that x (n) is the amplitude of the first voice signal. A variable i is a variable corresponding to time. N indicates a duration within the predetermined time period. A variable d is a variable with respect to time, and the range of the variable d is a range d1 to d2 determined in advance in accordance with the voice of a person. This range d1 to d2 may be, for example, provided in such a way that a range where the autocorrelation of a voice of a person is larger than a predetermined value is determined in advance in accordance with an actual voice. Here, xm is an average of x (n) in the predetermined time period.

$$R ( n ) = {max}_{d = {d}_{1}}^{{d}_{2}} [ \frac{{\sum }_{i = 0}^{N - 1} {( x ( n - i ) - xm )}^{2} \times {\sum }_{i = 0}^{N - 1} {( x ( n - d - i ) - xm )}^{2}}{{\sum }_{i = 0}^{N - 1} {( {( x ( n - i ) - xm )}^{2} - ( x ( n - d - i ) - xm ) )}^{2}} ] \qquad ( 3 )$$

p(n)=Σᵢ₌₀^{N-1}(x(n−i))² (4)

FIG. 5 is a diagram depicting an example of the method for detecting a vowel segment according to the second embodiment. In FIG. 5, assuming that the horizontal axis represents time, the autocorrelation 27 and the power 29 are depicted. Here, it is assumed that a correlation threshold THr and a power threshold THp are determined in advance. The vowel segment is determined as a range in which both the autocorrelation R (n) and the power p (n) exceed their respective thresholds. That is, the vowel detector 19 detects and outputs a segment from a start point Tstv1 of a vowel segment to an end point Tenv1 of the vowel segment and a segment from a start point Tstv2 of a vowel segment to an end point Tenv2 of the vowel segment depicted in FIG. 5, as vowel segments.

Note that the correlation threshold THr and the power threshold THp may be stored in advance in the threshold table 45 described below, so that, referring to the threshold table 45, the vowel detector 19 performs the above-mentioned processing. The vowel detector 19 may store the detected vowel segment in a vowel segment table 51 described below.

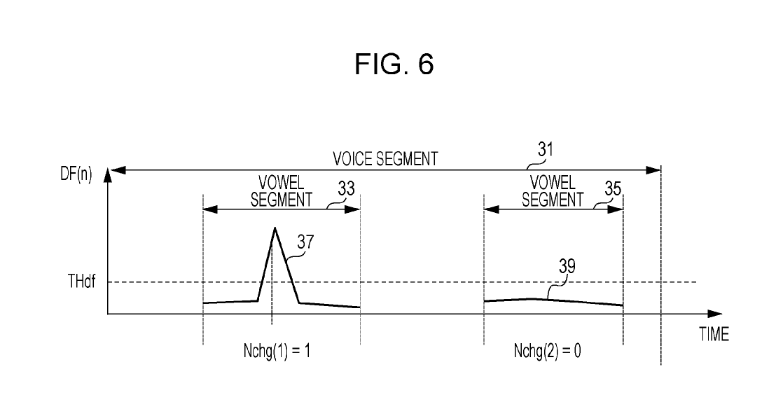

FIG. 6 is a diagram depicting an example of a method for computing the number of vowels. In FIG. 6, the horizontal axis represents time and the vertical axis represents the variation DF (n) in an envelope spectrum between adjacent predetermined time periods (frames). The vowel determining unit 3 performs linear predictive coding (LPC) analysis for each vowel segment detected by the vowel detector 19 to determine an envelope spectrum for every predetermined time period. Further, the vowel detector 19 determines the variation DF (n) of the envelope spectrum between adjacent frames. Note that the variation DF (n) of the envelope spectrum in the frame n is expressed by the following Formula 5.

DF(n)=F(n)−F(n−1) (5)

In Formula 5, F (n) indicates the envelope spectrum of an LPC analysis result in the frame n.

FIG. 6 depicts an example of the variation DF (n) computed as described above. In FIG. 6, it is depicted that a vowel segment 33 and a vowel segment 35 are detected in a voice segment 31. In the vowel segment 33, the variation DF (n) is depicted as an envelope spectrum variation 37. In the vowel segment 35, the variation DF (n) is depicted as an envelope spectrum variation 39. Additionally, it is assumed that a variation threshold THdf is determined in advance. Assuming that the vowel segment 33 is referred to as a vowel segment i=1, when the variation DF (n) the variation threshold THdf, a vowel change portion Nchg (1)=1 in the vowel segment i=1.

That is, the vowel change portion Nchg (1)=1 indicates that a vowel changes once in the detected vowel segment. When there are two ranges in which the variation DF (n)≧the variation threshold THdf in the vowel segment i, Nchg (i)=2, for example. As in the vowel segment 35, the variation DF (n)≧the variation threshold THdf is not satisfied in the vowel segment i=2, and thus the vowel change portion Nchg (2)=0. The number of vowels Nvo in the voice segment 31 is expressed using the number in a vowel segment and the sum of the numbers of vowel change portions in vowel segments as in the following Formula 6.

Nvo=Σᵢ(Nchg(i)+1) (5)

In such a way as described above, the vowel determining unit 3 determines the number of vowels Nvo in the first voice segment based on the number of vowel segments and, in every vowel segment, a portion where the temporal change of an envelope spectrum is equal to or larger than the threshold. Note that, when determining the number of vowels, the vowel determining unit 3 may make a determination referring to the variation threshold THdf stored in the threshold table 45 described below.

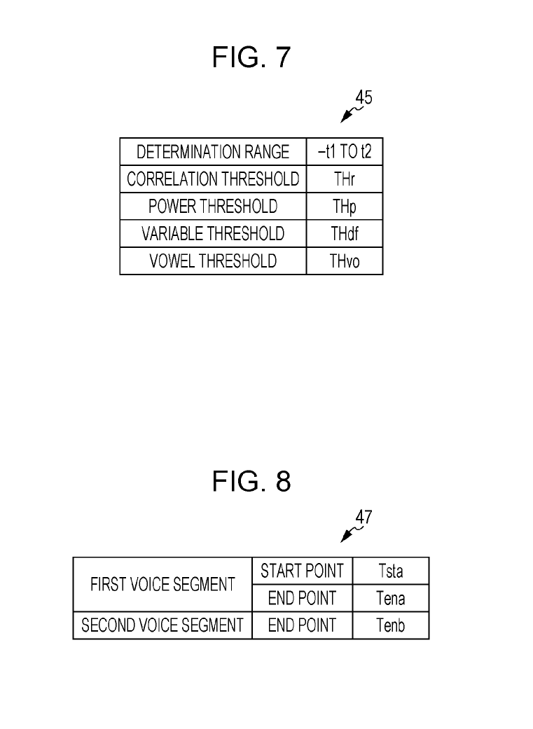

FIG. 7 depicts an example of the threshold table 45. The threshold table 45 is preferably stored in a storage unit of the voice processing device 20 in advance. The threshold table 45 includes a determining range −t1 to t2, the correlation threshold THr, the power threshold THp, the variation threshold THdf, and a vowel threshold THvo. As described above, the voice processing device 20 appropriately reads and uses thresholds from the threshold table 45.

FIG. 8 depicts an example of a voice segment table 47. The voice segment table 47 includes at least the start point Tsta of the first voice segment, the end point Tena of the first voice segment, and the end point Tenb of the second voice segment. The voice segment table 47 may include the start point Tsta of the second voice segment. The voice segment table 47 is generated by processing with the first voice detector 15 and with the second voice detector 17.

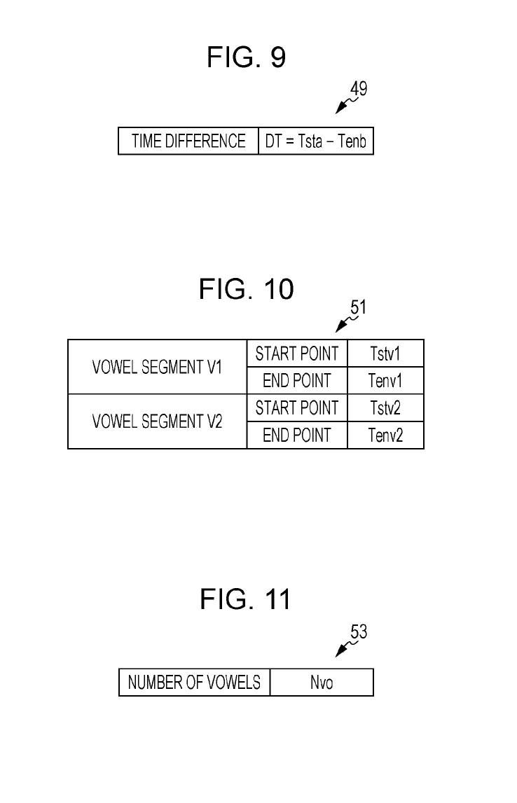

FIG. 9 is a diagram illustrating an example of time difference data 49. The time difference data 49 includes the time difference DT computed by the backchannel-response detector 7. FIG. 10 depicts an example of the vowel segment table 51. The vowel segment table 51 holds start points and end points of vowel segments detected by the vowel detector 19. For example, the vowel segment table 51 includes a start point Tstv1 and an end point Tenv1 for a vowel segment V1. The vowel segment table 51 also includes a start point Tstv2 and an end point Tenv2 for a vowel segment V2. Note that the number of vowel segments is not limited to two, and the start point and the end point are held for each of the vowel segments detected by the vowel detector 19. FIG. 11 is a diagram illustrating an example of vowel number data 53. The vowel number data 53 includes the number of vowels Nvo determined by the vowel determining unit 3.

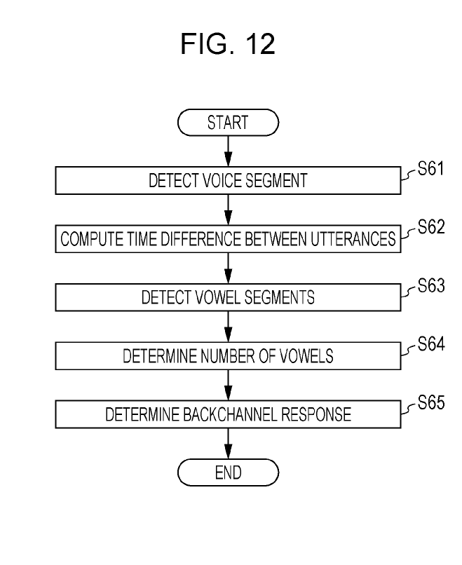

FIG. 12 is a flowchart illustrating operations of the voice processing device 20 according to the second embodiment. As illustrated in FIG. 12, in the voice processing device 20, the first voice detector 15 detects the first voice segment from the first voice signal. The second voice detector 17 detects the second voice segment from the second voice signal (S61). Note that, at this point, at least the start point Tsta of the first voice segment, the end point Tena of the first voice segment, and the end point Tenb of the second voice second voice segment are preferably detected.

The time-difference computing unit 5 computes the time difference DT=the start point Tsta of the first voice segment—the end point Tenb of the second voice segment (S62). From the first voice signal, the vowel detector 19 computes the autocorrelation R (n) and the power p (n), as described above, and detects vowel segments (S63). In the detected vowel segment, the vowel determining unit 3 determines a variation DF (i) of an envelope spectrum, detects a vowel change portion Nchg (i) by making a comparison with the variation threshold THdf, and determines the number of vowels Nvo (S64).

The backchannel-response detector 7 refers to the threshold table 45, and determines the first voice segment as a backchannel-response segment when the time difference DT is within the predetermined range −t1 to t2 and when the number of vowels Nvo is equal to or less than the vowel threshold THvo (S65). The vowel threshold THvo is, for example, “1”, “2”, or the like.

As described in detail above, in the voice processing device 20, the first voice detector 15 detects the first voice segment. The second voice detector 17 detects the second voice segment. The vowel detector 19 detects, for example, vowel segments in accordance with the autocorrelation R (n), the power p (n), the correlation threshold THr, and the power threshold THp. The time-difference computing unit 5 computes the time difference DT. The vowel determining unit 3 determines the vowel change portion Nchg (i) based on the variation DF (n) in an envelope spectrum and the variation threshold THdf. The vowel determining unit 3 determines the number of vowels Nvo based on the number of vowel segments and the vowel change portion Nchg (i). The backchannel-response detector 7 determines the first voice segment as a backchannel-response segment when the time difference DT is within the predetermined time range −t1 to t2 and when the number of vowels Nvo is equal to or less than the vowel threshold THvo.

As described above, with the voice processing device 20 according to the second embodiment, a change portion of a vowel is detected by using the envelope spectrum variation 37 in addition to advantages provided by the voice processing device 1 according to the first embodiment. Consequently, it is possible to determine the number of vowels with higher accuracy. This, in turn, enables a backchannel response to be determined with higher accuracy.

Note that, in this embodiment, a method for determining a vowel segment and the number of vowels is not limited to that described above. For example, determination of a vowel segment is not limited to cases where the vowel segment is determined as a range in which both the autocorrelation R (n) and the power p (n) exceed their respective thresholds, and modifications thereof may be made in which a vowel segment is determined as a range in which either of the autocorrelation R (n) and the power p (n) exceeds its threshold.

The vowel threshold THvo is not limited to that described above, and may be preferably set as a number that avoids a situation in which a segment that does not include a vowel is detected. For example, for a language different from that originally intended, a modification such as a method of using the vowel threshold THvo characteristic of the language is conceivable. The determination of the number of vowels is not limited to that described above and may be made by using another method such as the method described in the document “Voice 1” mentioned above. For example, the method described in the document “Voice 1” mentioned above may be performed for vowel segments determined using the method described above.

(First Modification)

A first modification that is applicable to the voice processing device 1 according to the first embodiment or the voice processing device 20 according to the second embodiment will now be described. This modification is a modification for detection of vowel segments. In this modification, configurations and operations similar to those in the first embodiment or in the second embodiment are denoted by the same reference numerals, and redundant description thereof is omitted.

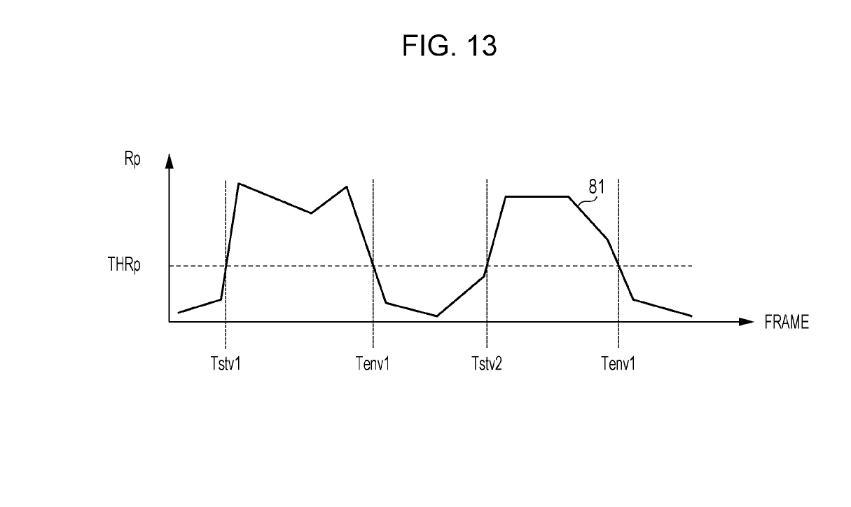

FIG. 13 is a diagram depicting an example of a vowel segment detection method according to this modification. In FIG. 13, the horizontal axis represents a frame, and the vertical axis represents a pitch property Rp of a power spectrum. In this modification, the vowel detector 19 performs time-frequency transform of a first voice signal, for example, using fast Fourier transform (FFT) to compute a power spectrum P (f)=|X (f)|². Further, the vowel detector 19 computes a pitch variation Rp=Σ (|P (f)−P (f−1)|. In FIG. 13, a pitch variation 81 indicates a temporal shift in the pitch variation Rp. Here, it is assumed that when the pitch variation Rp exceeds a pitch threshold THRp determined in advance, a vowel segment is determined. Consequently, as depicted in FIG. 13, a vowel segment 82 and a vowel segment 83 are detected.

In such a way, a vowel segment may be detected as a segment in which the pitch variation of a frequency spectrum of a voice signal is larger than a threshold. By using such a method, it is also possible to detect vowel segments with high accuracy.

When, for example, the power (sound volume) of a voice signal exceeds a predetermined value, the segment where the excess occurs may be determined as a vowel segment.

(Second Modification)

A second modification that is applicable to the voice processing device 1 according to the first embodiment, the voice processing device 20 according to the second embodiment, and the first modification will now be described. This modification is a modification for the case where the voice is an English voice. In this modification, configurations and operations similar to those in the first embodiment, the second embodiment, and the first modification are denoted by the same reference numerals, and redundant description thereof is omitted. The second modification is applicable to any of the first embodiment, the second embodiment, and the first modification.

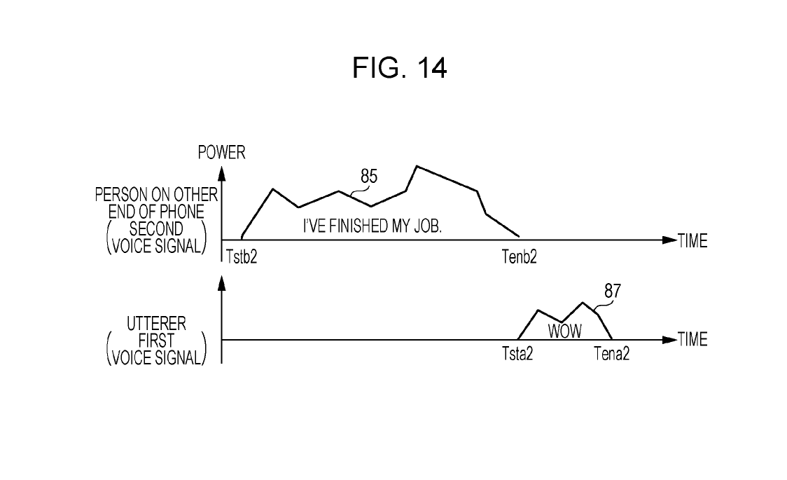

FIG. 14 is a diagram depicting an example of a backchannel response according to the second modification. In FIG. 14, the horizontal axis represents time, and the vertical axis represents the power of a voice signal. A second voice signal 85 represents a signal corresponding to an utterance of the second speaker saying, for example, “I've finished my job.” A first voice signal 87 represents a signal corresponding to a backchannel response “Wow” uttered to the second voice signal 85.

At this time, the second voice segment is determined to be from a start point Tstb2 of the second voice segment to an end point Tenb2 of the second voice segment. The first voice segment is determined to be from a start point Tsta2 of the first voice segment to an end point Tena2 of the first voice segment. The determination of a voice segment may be performed, for example, by using the method described in Japanese Laid-open Patent Publication No. 2004-272052 or the method described in the second embodiment or the first modification. Note that the start points and end points of the first voice segment and the second voice segment may be relative time points.

Also in English cases, a backchannel response is considered to occur during or immediately after utterance of the conversation partner. Consequently, the backchannel-response detector 7 determines a backchannel response based on the time difference DT between the start point Tsta2 of the first voice segment and the end point Tenb2 of the second voice segment. That is, it is assumed that the time difference DT is expressed by the following Formula 7.

DT=Tsta2−Tenb2 (7)

At this point, the time difference DT may be within a time period determined in advance. That is, Formula 2 mentioned above is satisfied. For the sake of explanatory convenience, Formula 2 is given again below.

−t1≦DT≦t2 (2)

where the time period t1 and the time period t2 are both positive real numbers. The time period t1 and the time period t2 may determine a time difference between backchannel responses that is statistically probable, for example, from actual conversations including backchannel responses.

Another feature of a backchannel response is that the backchannel response is formed of a small number of vowels. That is, examples of backchannel responses in English may include “Yes”, “Yep”, “Yeah”, “Right”, “I see”, “Sure”, “Maybe”, “Great”, “Cool”, “Too bad”, “Really, and “Oh”. These are voices each including a small number of vowels. The small number may be assumed to be, for example, less than three. The number of vowels may be determined by identifying a vowel, for example, by using the method described in the document “Voice 1” mentioned above.

As described above, in English cases, in the same way as in Japanese cases, it is possible to detect a backchannel response by a method in which a backchannel response is determined when the time difference DT is within the predetermined range and when the number of vowels included in the first voice segment is equal to or less than the predetermined number. Additionally, this modification is applicable to the voice processing device 1 according to the first embodiment, the voice processing device 20 according to the second embodiment, or the first modification, and thus similar advantages to those in Japanese cases may be achieved.

### Third Embodiment

A voice processing device 100 according to a third embodiment will now be described. The third embodiment is an example in which an utterance intention and the strength of the utterance intention are further determined in the first embodiment, the second embodiment, the first modification, or the second modification. In this embodiment, configurations and operations similar to those in the first embodiment, the second embodiment, the first modification, and the second modification are denoted by the same reference numerals, and redundant description thereof is omitted.

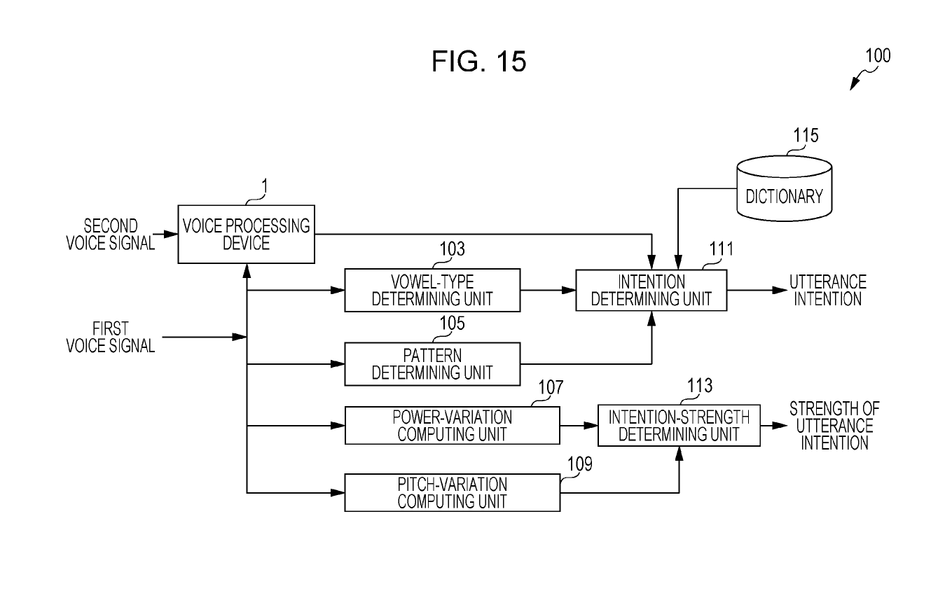

FIG. 15 is a block diagram illustrating a functional configuration of the voice processing device 100 according to the third embodiment. As illustrated in FIG. 15, the voice processing unit 100 includes the voice processing device 1. In place of the voice processing device 1, the voice processing device 20 may be used. The voice processing device 100 further includes a vowel-type determining unit 103, a pattern determining unit 105, a power-variation computing unit 107, a pitch-variation computing unit 109, an intention determining unit 111, an intention-strength determining unit 113, and a dictionary 115.

The voice processing device 1 outputs a backchannel-response determination result to the intention determining unit 111. The vowel-type determining unit 103 determines the type of a vowel based on the first voice signal. A determination of the type of a vowel may be made, for example, by using the method described in the document “Voice 1” mentioned above.

The pattern determining unit 105 determines the pattern of a variation in pitch in a vowel segment. The power-variation computing unit 107 computes a variation in the power of a voice in a vowel segment. The pitch-variation computing unit 109 computes a pitch variation in a vowel segment.

The intention determining unit 111 determines the intention of the second speaker based on a determination result of the voice processing device 1, determination results of the vowel-type determining unit 103 and the pattern determining unit 105, and information of the dictionary 115. The intention-strength determining unit 113 determines the strength of an intention determined by the intention determining unit 111 based on computation results of the power-variation computing unit 107 and the pitch-variation computing unit 109. The dictionary 115 stores information in which vowel types, patterns of variations in pitch, and intentions are associated with one another.

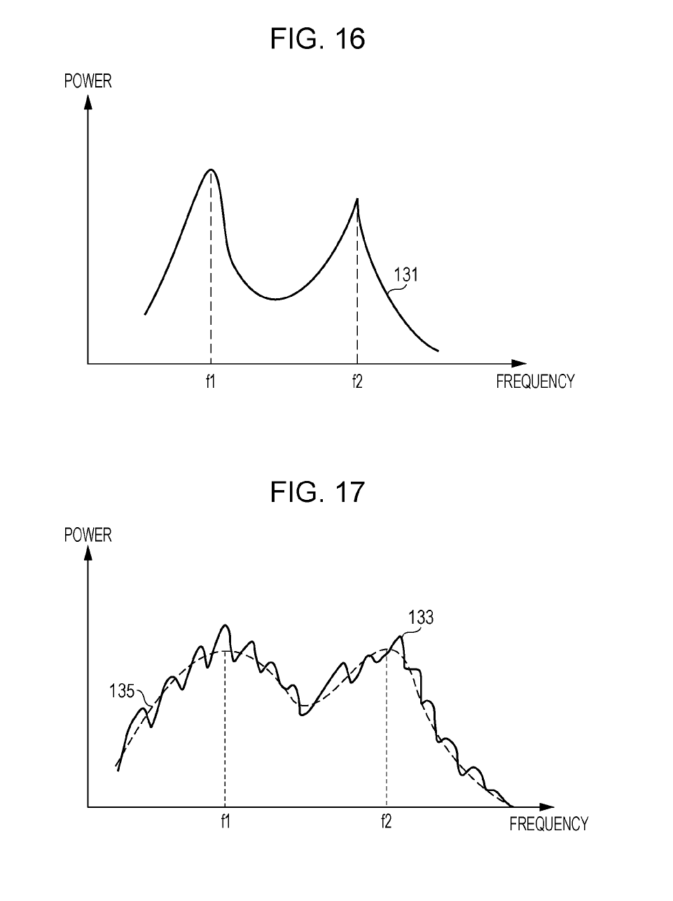

Next, a method for determining a vowel type performed by the vowel-type determining unit 103 is described with reference to FIG. 16 and FIG. 17. FIG. 16 is a diagram depicting an example of the method for determining a vowel type by utilizing LPC analysis. In FIG. 16, the horizontal axis represents frequency, and the vertical axis represents power. An LPC analysis result 131 represents, for example, a result obtained by performing LPC analysis on a voice signal in a predetermined time period of a detected vowel segment. In accordance with a first formant frequency f1 and a second formant frequency f2 determined by the LPC analysis, the vowel-type determining unit 103 determines a vowel type. The determination of a vowel type in accordance with the value of a formant frequency may be made, for example, by using the related-art technique described in the document “Voice 1” or the like.

FIG. 17 depicts an example of a result obtained by performing FFT and smoothing on a voice signal in a predetermined time period of the detected vowel segment. In FIG. 17, the horizontal axis represents frequency, and the vertical axis represents power. An FFT result 133 indicates an example of a result obtained by performing FFT on a voice signal. A smoothing power 135 indicates an example of a result obtained by smoothing the FFT result 133. As depicted in FIG. 17, with the smoothing power 135, the formant frequencies f1 and f2 may be obtained, as is the case with PLC analysis. As a result, it is possible to determine a vowel type using these frequencies.

FIG. 18 is a diagram depicting an example of a variation in pitch. In FIG. 18, the horizontal axis represents time, and the vertical axis represents frequency. In FIG. 18, the first voice segment Tsta to Tena and a vowel segment Tstv1 to Tenv1 are depicted. A pitch variation 137 represents a temporal variation of a pitch p (n) determined from a voice signal in the vowel segment. The pitch p (n) may be determined, for example, using an existing method, in accordance with autocorrelation of a voice signal and so forth.

In FIG. 18, a time point Tm indicates a time point at which a vowel segment is temporally halved. An average pitch fp1 is the average of the first half Tstv1 to Tm of the vowel segment. An average pitch fp2 is the average of the second half Tm to Tenv1 of the vowel segment. For example, the pattern determining unit 105 may determine that the pattern of a variation in pitch is “decrease” in the case of fp1≧fp2, and that the pattern of a variation in pitch is “increase” in the case of fp1<fp2. The pattern determining unit 105 may determine that the pattern of a variation in pitch is “increase” in the case where a straight line drawn by a least squares method with respect to the pitch variation 137 in a vowel segment has a positive slope, and that the pattern is “decrease” in the case where the straight line has a negative slope.

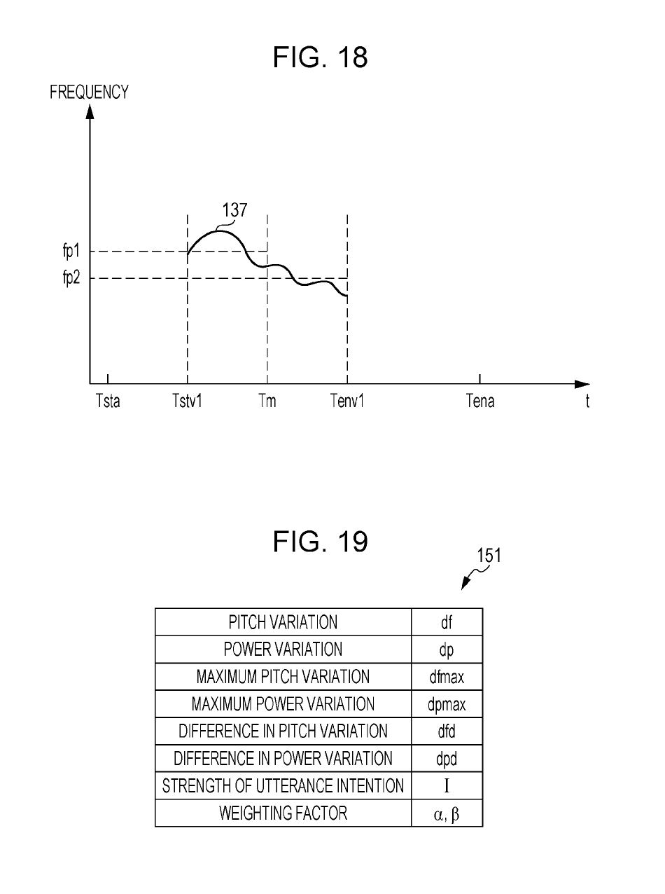

FIG. 19 depicts an example of a variation table 151. The variation table 151 includes a pitch variation df, a power variation dp, a maximum pitch variation dfmax, a maximum power variation dpmax, a difference in pitch variation dfd, a difference in power variation dpd, the strength of an utterance intention I, and weighting factors α and β.

The pitch-variation computing unit 109 computes the pitch variation df using the following Formula 8. The power-variation computing unit 107 computes the power variation dp using the following Formula 9.

df=f(n)−f(n−1) (8)

dp=p(n)−p(n−1) (9)

where, the power may be, for example, such that p (n)=(x (n))².

Further, the pitch-variation computing unit 109 computes, for example, the maximum pitch variation dfmax in a vowel segment using Formula 10 given below. The power-variation computing unit 107 computes the maximum power variation dpmax using Formula 11. Note that the initial value is set to “0”.

dfmax=df(n) (df(n)>dfmax)

dfmax=dfmax (df(n)≦dfmax) (10)

dpmax=dp(n) (dp(n)>dpmax)

dpmax=dpmax (dp(n)≦dpmax) (10)

Here, for example, the pitch-variation computing unit 109 computes the difference dfd between the maximum pitch variation dfmax and the average of the pitch variation df (n) using Formula 12 given below. The power-variation computing unit 107 computes the difference dpd between the maximum power variation dpmax and the average of the power variation dp (n) using Formula 13 given below.

dfd=dfmax−ave(df(n)) (12)

dpd=dpmax−ave(dp(n)) (13)

The intention-strength determining unit 113 computes the intention strength I, which is obtained by weighting addition in accordance with the pitch variation df (n) and the power variation dp (n), using the following Formula 14.

I=α×dfd+β×dpd (14)

Here, the coefficient α indicates the degree of contribution of the pitch variation to the intention strength I. The coefficient β indicates the degree of contribution of the power variation to the intention strength I. The coefficients α and β may be determined in advance by learning the degrees of contribution of a pitch variation and a power variation in advance based on a voice signal whose utterance intention is known. Computation of the intention strength I includes the case where either the coefficient α or the coefficient β is “zero”. Consequently, the power-variation computing unit 107 and the pitch-variation computing unit 109 may be such that substantially at least one of them is included.

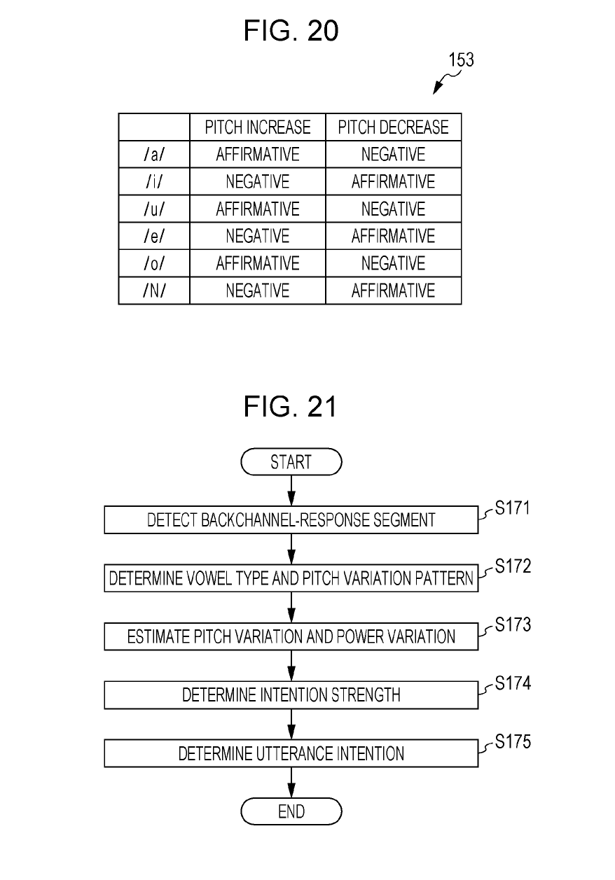

FIG. 20 is a table depicting an example of the dictionary 115. The dictionary 115 is information in which, for each of vowels (a, i, u, e, o, N), the intention of the case where the pitch increases and the intention of the case where the pitch decreases are indicated by either “affirmative” or “negative”. The intention determining unit 111 determines whether the intention in accordance with the vowel type determined by the vowel-type determining unit 103 and the pattern of “increase” or “decrease” determined by the pattern determining unit 105 is “affirmative” or “negative”.

Note that when the intention strength I is equal to or less than a predetermined value, the intention determining unit 111 may determine that the utterance intention for the vowel is “no intention”, and inhibit a determination of the intention with reference to the dictionary 115. Additionally, in this case, a modification may be made in which a backchannel-response segment is inhibited from being output as a determination result. When there are a plurality of vowel types with the intention strength I exceeding the predetermined value, the intention of a vowel type corresponding to the highest intention strength I may be output.

FIG. 21 is a flowchart illustrating operations of the voice processing device 100 according to this embodiment. As illustrated in FIG. 21, the voice processing device 1 detects a backchannel-response segment based on the first voice signal and the second voice signal (S171). As described above, any of the first embodiment, the second embodiment, the first modification, and the second modification may be applied to detection of a backchannel-response segment. For example, the voice processing device 1 outputs, as a backchannel-response segment, the start point Tsta of the first voice segment and the end point Tena of the first voice segment in the voice segment table 47. The voice processing device 1 also outputs information on a vowel segment, for example, as in the vowel segment table 51.

The vowel-type determining unit 103 determines a vowel type included in the vowel segment detected by the voice processing device 1. The pattern determining unit 105 determines whether the pattern of a variation in pitch is “increase” or “decrease” (S172).

The power-variation computing unit 107 computes the difference in power variation dpd based on the power variation dp (n). The pitch-variation computing unit 109 computes the difference dfd in pitch variation based on the pitch variation df (n). By these computations, the power variation and the pitch variation are estimated.

The intention-strength determining unit 113 computes the intention strength I in accordance with the calculated difference in power variation dpd and the calculated difference in pitch variation dfd (S174). Referring to the vowel type and the pattern of a variation in pitch in the dictionary 115, the intention determining unit 111 determines the intention of an utterance (S175). The intention of an utterance is determined, for example, as either “affirmative” or “negative”. Note that although the value of the intention strength I may be output as the intention strength, a modification may be made in which any of “strong”, “medium”, and “weak” is output in accordance with the value, for example. The method for computing an intention strength is not limited to the above, a different calculation method that enables a determination similar to the above may be used.

As described above, with the voice processing device 100 according to the third embodiment, the intention of an utterance and an utterance strength are determined in a backchannel-response segment determined by the voice processing device 1, the voice processing device 20, or the like. The utterance intention is preferably determined in accordance with the vowel type, the pattern of a variation in pitch, and the intention strength included in a backchannel-response segment.

As described above, with the voice processing device 100 according to the third embodiment, in addition to the advantages of the first embodiment, the second embodiment, the first modification, and the second modification, it is possible to determine the intention of the first speaker. The intention is determined in accordance with the vowel type included in a backchannel response, a pattern of a variation in pitch of a backchannel response, a pitch variation, the intention strength based on a power variation, and so forth. Thus, a backchannel-response detection and an intention determination may be achieved with high accuracy.

Additionally, since the intention determining unit 111 may determine an intention when the intention strength computed in accordance with a power variation and a pitch variation of a voice signal in a vowel segment is equal to or larger than a predetermined value, a wrong determination in such a case where an intention is determined in a segment other than the segment of a backchannel response may be inhibited.

### Fourth Embodiment

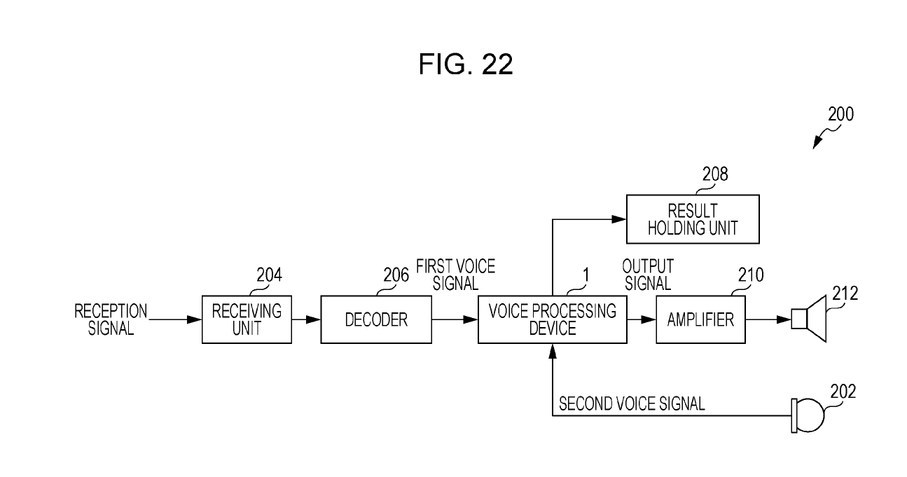

FIG. 22 is a block diagram illustrating an example of a configuration in the case where the voice processing device 1 is applied to a telephone set 200. The telephone set 200 is an example in which the voice processing device 1 according to the first embodiment is applied to analysis of the number of backchannel responses of the person on the other end of the phone, for example. The telephone set 200 may be, for example, a portable telephone.

As illustrated in FIG. 22, the telephone set 200 includes, in addition to the voice processing device 1, a microphone 202, a receiving unit 204, a decoder 206, a result holding unit 208, an amplifier 210, and a speaker 212. In the telephone set 200, the first voice signal is received with the receiving unit 204 and decoded with the decoder 206, and thus is input to the voice processing device 1. The first voice signal is also amplified with the amplifier 210 and is output as a voice with the speaker 212. The second voice signal is input with the microphone 202 and is input to the voice processing device 1. A backchannel segment detected by the voice processing device 1 is, for example, held as a result in the result holding unit 208. The voice processing device 1 may output only the result of whether the backchannel response has been detected, and be held in the result holding unit 208.

As described above, the telephone set 200 may detect whether, as a voice of the person on the other end of the phone, a backchannel response has been made to the second voice signal, which is a voice of the user of the telephone set 200, and output a detection result. The number of backchannel responses may be left on record by being stored in the result holding unit 208.

As described above, with the telephone set 200 according to the fourth embodiment, a backchannel response may be detected with high accuracy. Additionally, with the telephone set 200, analysis of a call may be made by detecting the number of backchannel responses.

Note that any of the voice processing devices according to the second embodiment, the third embodiment, the first modification, and the second modification may be used by applying it to the telephone set 200. In such a case, advantages of the embodiments may be achieved in addition to the advantages of the fourth embodiment described above.

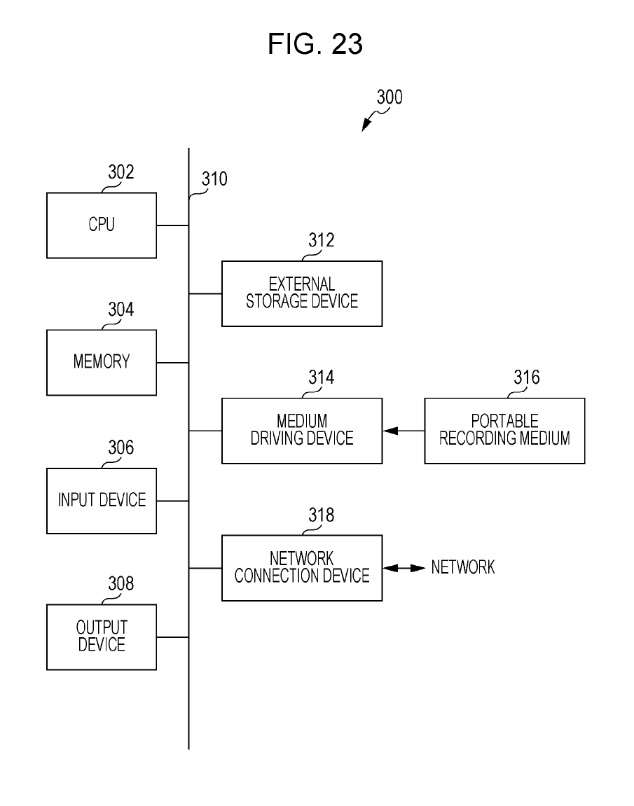

Here, an example of a computer commonly applied for causing the computer to perform operations of the voice processing method according to the first to fourth embodiments and the first and second modifications is described. FIG. 23 is a block diagram illustrating an example of a hardware configuration of a standard computer. As illustrated in FIG. 23, in a computer 300, a central processing unit (CPU) 302, a memory 304, an input device 306, an output device 308, an external storage device 312, a medium driving device 314, a network connection device 318, and so forth are connected via a bus 310.

The CPU 302 is a processing unit that controls operations of the entire computer 300. The memory 304 is a storage unit for storing, in advance, a program that controls operations of the computer 300 and for use as workspace as occasion arises when the program is executed. The memory 304 is, for example, a random access memory (RAM), a read-only memory (ROM), or the like. The input device 306 is a device that, when operated by the user of the computer, acquires input of a variety of information from the user that is associated with the operation content, and sends the acquired input information to the CPU 302, and is, for example, a keyboard device, a mouse device, or the like. The output device 308 is a device that outputs a result of processing performed by the computer 300, and includes a display device and so forth. The display device, for example, displays a text and an image in accordance with display data sent by the CPU 302.

The external storage device 312 is, for example, a storage device, such as a hard disk, and is a device that stores various control programs executed by the CPU 302, acquired data, and so forth. The medium driving drive 314 is a device for writing and reading to and from the portable recording medium 316. The CPU 302 may perform a variety of control processing by reading a predetermined control program recorded on the portable recording medium 316 via the medium driving device 314 and executing the program. The portable recording medium 316 is, for example, a compact disc (CD)-ROM, a digital versatile disc (DVD), a universal serial bus (USB) memory, or the like. The network connection device 318 is an interface device that manages transfer of a variety of data that is performed with external devices in wired or wireless manners. The bus 310 is a communication path that connects the devices mentioned above with each other and through which data is exchanged.

A program for causing a computer to execute the voice processing method according to the first to fourth embodiments described above is stored, for example, in the external storage device 312. The CPU 302 reads the program from the external storage device 312 and executes the program using the memory 304, thereby performing operations of voice processing. At this point, first, a control program for causing the CPU 302 to perform a process for voice processing is created and stored in the external storage device 312. Then, a predetermined instruction is given from the input device 306 to the CPU 302 to cause the CPU 302 to read this control program from the external storage device 312 and to execute the control program. The program may also be stored in the portable recording medium 316.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A voice processing device comprising:
a backchannel-response detector configured to detect, from a first voice signal including a voice of a first speaker, a backchannel-response segment including a voice corresponding to a backchannel response made by the first speaker, using,
a start point of a first voice segment detected from the first voice signal,
an end point of a second voice segment detected from a second voice signal including a voice of a second speaker uttered before the voice of the first speaker, and
the number of vowels detected from the first voice segment of the first voice signal.

2. The voice processing device according to claim 1, further comprising:
a time-difference computing unit configured to compute a time difference between the start point of the first voice segment and the end point of the second voice segment; and
a vowel determining unit configured to determine the number of vowels in the first voice segment, based on voice signals of vowel segments detected from the first voice segment,
wherein the backchannel-response detector is configured to determine that when the time difference is shorter than a predetermined value, and the number of vowels is equal to or less than a predetermined number, the first voice segment is the backchannel-response segment.

3. The voice processing device according to claim 2,
wherein the vowel determining unit is configured to determine an envelope spectrum for each predetermined time period from a voice signal of each of the vowel segments, to detect vowel changes in the vowel segments based on temporal variations in the envelope spectra, and to determine the number of vowels based on a number of the vowel segments in the first voice segment and a number of the vowel changes.

4. The voice processing device according to claim 2,
wherein the vowel segments are detected in accordance with autocorrelation and power of the first voice signal of the first voice segment.

5. The voice processing device according to claim 1, further comprising:
at least one of
a power-variation computing unit configured to compute a power variation of the backchannel-response segment, and
a pitch-variation computing unit configured to compute a pitch variation of the backchannel-response segment; and
an intention-strength determining unit configured to determine an intention strength of a voice in the backchannel-response segment, based on a computation result of at least one of the power variation computing unit and the pitch-variation computing unit.

6. The voice processing device according to claim 1, further comprising:
a vowel-type determining unit configured to determine a type of a vowel in each of the vowel segments;
a pattern determining unit configured to determine a pattern of a variation in pitch in the backchannel-response segment; and
an intention determining unit configured to determine an utterance intention of the first speaker in accordance with the type of a vowel and the pattern.

7. The voice processing device according to claim 6,
wherein the intention determining unit is configured to determine the intention when the intention strength is larger than a predetermined value.

8. A voice processing method executed by a computer, comprising:
detecting, from a first voice signal including a voice of a first speaker, a backchannel-response segment including a voice corresponding to a backchannel response of the first speaker, using
a start point of a first voice segment detected from the first voice signal,
an end point of a second voice segment detected from a second voice signal including a voice of a second speaker uttered before the voice of the first speaker, and
a number of vowels detected from the first voice segment of the first voice signal.

9. The voice processing method according to claim 8,
wherein a time difference between the start point of the first voice segment and the end point of the second voice segment is computed,
wherein the number of vowels in the first voice segment is determined based on voice signals of vowel segments detected from the first voice segment, and
wherein when the time difference is shorter than a predetermined value, and the number of vowels is equal to or less than a predetermined number, it is determined that the first voice segment is the backchannel-response segment.

10. The voice processing method according to claim 9,
wherein an envelope spectrum for each predetermined time period is determined from a voice signal of each of the vowel segments, vowel changes in the vowel segments are detected based on temporal variations in the envelope spectra, and the number of vowels is determined based on a number of the vowel segments in the first voice segment and a number of the vowel changes.

11. The voice processing method according to claim 9,
wherein the vowel segments are detected in accordance with autocorrelation of the first voice signal of the first voice segment.

12. The voice processing method according to claim 8,
wherein an intention strength of a voice in the backchannel-response segment is determined in accordance with at least one of a power variation of the backchannel-response segment and a pitch variation of the backchannel-response segment.

13. The voice processing method according to claim 8,
wherein an utterance intention of the first speaker is determined in accordance with the type of a vowel in each of the vowel segments and a pattern of a variation in pitch in the backchannel-response segment.

14. The voice processing method according to claim 13,
wherein the utterance intention is determined when the intention strength is larger than a predetermined value.

15. A computer-readable recording medium storing a voice processing program for causing a computer to execute a procedure, the procedure comprising:
detecting, from a first voice signal including a voice of a first speaker, a backchannel-response segment including a voice corresponding to a backchannel response of the first speaker, using
a start point of a first voice segment detected from the first voice signal,
an end point of a second voice segment detected from a second voice signal including a voice of a second speaker uttered before the voice of the first speaker, and
a number of vowels detected from the first voice segment of the first voice signal.
